(19) United States
(12) Patent Application Publication
(10) Pub. No.: US 2013/0178578 A1
(43) Pub. Date: Jul. 11, 2013

(54) MOISTURE-PROOF INSULATING MATERIAL

(71) Applicants: Kazuhiko Ooga, Minato-ku (JP); Ritsuko Azuma, Minato-ku (JP)

(72) Inventors: Kazuhiko Ooga, Minato-ku (JP); Ritsuko Azuma, Minato-ku (JP)

(73) Assignee: SHOWA DENKO K.K., Minato-ku, Tokyo (JP)

(21) Appl. No.: 13/824,253

(22) PCT Filed: Oct. 17, 2011
(86) PCT No.: PCT/JP2011/073846

§ 371 Date: Mar. 15, 2013

(30) Foreign Application Priority Data
Oct. 22, 2010 (JP) 2010-237476

(51) Int. Cl. H01B 7/28

(52) U.S. Cl. CPC H01B 7/28
USPC 524/575; 524/578

(57) ABSTRACT

Provided are: a moisture-proof insulating material having superior long-term insulating reliability and adhesiveness to polyimides and glass substrates, and has a solid content concentration that can secure a thickness that realizes sufficient moisture-proof performance after application and drying in a viscosity region that can be easily coated by means of a dispenser; and an electronic component that has been insulation-processed by means of the moisture-proof insulating material. The moisture-proof insulating material contains a styrene-based thermoplastic elastomer, a tackifying agent, and a solvent, and is characterized by the solvent containing an aliphatic hydrocarbon solvent (for example, methylcyclohexane or cyclohexane) having a boiling point that is at least 80° C. and less than 110° C. The solvent preferably further contains an aliphatic hydrocarbon solvent (for example, ethylcyclohexane or dimethylcyclohexane) having a boiling point that is at least 110° C. and less than 140° C.

### TECHNICAL FIELD

The present invention relates to a moisture-proof insulating material for an electronic component, excellent in workability and quick-drying property, and to an electronic component insulation-processed with the moisture-proof insulating material.

### BACKGROUND ART

Conventionally, coating with an insulative film has been carried out for the purpose of protecting a metal-exposed portion such as a packaged circuit board or an electrode from moisture, dust, a corrosive gas or the like in the step of producing an electronic instrument. There are ultraviolet curing, moisture curing and solvent drying types of coating materials, in which acrylic resin, silicone resin, styrene block copolymer resin and the like have been used, respectively.

A moisture curing-type coating material is excellent in moisture resistance but has the problem that the protection of the metal of a circuit or an electrode must be thick due to moisture vapor permeability.

The ultraviolet curing-type coating material is widely used because of being able to be cured in a short time and being excellent in productivity. As an example of an ultraviolet curing-type coating material, a urethane-modified acrylate compound derived from a polyolefin polyol described in Patent Document 1 or a polycarbonate polyol described in Patent Document 2, or the like is known.

The step of producing an electronic instrument includes a repair step in which, when any defect is confirmed after having carried out a coating process with a moisture-proof insulating material, a component in which the defect occurs is removed to join a new component again. Since a site in which any defect occurs is uncertain when the component is rejoined in the repair step, positioning during ultraviolet irradiation is difficult, so that the solvent drying-type coating material is often used.

As a composition for the solvent drying type coating material, a composition comprising a styrene-based thermoplastic elastomer, a tackifier and toluene is disclosed in Patent Document 3. However, it is not environmentally preferred to use a toxic solvent such as toluene.

Further, a composition comprising a styrene-based thermoplastic elastomer, a tackifier, a silane coupling agent and ethylcyclohexane is disclosed in Patent Document 4 and Patent Document 5. However, in a solvent containing ethylcyclohexane as a main component, when a solid content concentration is increased to achieve a quicker-drying property, the viscosity of the composition becomes high, so that workability (that is, potting performance) is deteriorated. Further, increase in the amount of ethylcyclohexane to decrease the viscosity has caused a situation in which time before tack disappears at room temperature is around 5 minutes or longer when a film thickness after drying of around 130 μm is formed.

### CITATION LIST

### Patent Document

Patent Document 1: Japanese Laid-open Patent Publication No. 2007-308681

Patent Document 2: Japanese Laid-open Patent Publication No. 2007-332279

Patent Document 3: Japanese Laid-open Patent Publication No. 2003-145687

Patent Document 4: Japanese Laid-open Patent Publication No. 2005-126456

Patent Document 5: Japanese Laid-open Patent Publication No. 2005-162986

### SUMMARY OF INVENTION

### Technical Problem

Since a solvent drying type coating material is not attended with a curing reaction, it is needed to be capable of realizing physical properties only by application and drying thereof, and, therefore, the molecular weight of a resin cannot but increase. However, the viscosity of the coating material is increased to deteriorate workability with increasing the molecular weight of the resin. Alternatively, when the coating material is diluted to secure workability, there has been apprehension that the thickness of the coating film after application and drying is reduced to result in poor moisture-proof properties, and, furthermore, there has been a problem that productivity is deteriorated since time before tack on the surface of a coating film disappears after the application is long.

In the solvent drying type coating material, shift to a subsequent step after around 3 minutes of application thereof is desired for promoting the efficiency of steps, and a quick-drying property is demanded. However, since a defect such as clogging of the top of a syringe during potting occurs when drying is too quick, an adequate drying property is needed.

### Solution to Problem

As a result of repeating extensive research in order to solve the above-described problems, the present inventors found that an excellent moisture-proof insulating film that has low viscosity and a sufficient solid content concentration and realizes a quick-drying property is obtained by using an aliphatic hydrocarbon solvent having a boiling point of 80° C. or more and less than 110° C. as the main component of a solvent in a solvent drying type coating material containing a styrene-based thermoplastic elastomer, and the present invention was thus accomplished.

That is, the present invention (I) is configured as a moisture-proof insulating material comprising a styrene-based thermoplastic elastomer, a tackifier and a solvent, wherein the solvent contains an aliphatic hydrocarbon solvent having a boiling point of 80° C. or more and less than 110° C.

The present invention (II) is configured as an electronic component insulation-processed by using the moisture-proof insulating material according to the present invention (I).

Furthermore, the present invention relates to [1] to [10] described below.

[1] A moisture-proof insulating material comprising a styrene-based thermoplastic elastomer, a tackifier and a solvent, wherein the solvent contains an aliphatic hydrocarbon solvent having a boiling point of 80° C. or more and less than 110° C.

[2] The moisture-proof insulating material according to [1], wherein the solvent further contains an aliphatic hydrocarbon solvent having a boiling point of 110° C. or more and less than 140° C.

[3] The moisture-proof insulating material according to [2], wherein a weight ratio between the aliphatic hydrocarbon solvent having a boiling point of 80° C. or more and less than 110° C. and the aliphatic hydrocarbon solvent having a boiling point of 110° C. or more and less than 140° C., contained in the moisture-proof insulating material, ranges from 50:50 to 95:5.

[4] The moisture-proof insulating material according to any of [1] to [3], wherein the aliphatic hydrocarbon solvent having a boiling point of 80° C. or more and less than 110° C. is cyclohexane and/or methylcyclohexane.

[5] The moisture-proof insulating material according to any of [2] to [4], wherein the aliphatic hydrocarbon solvent having a boiling point of 110° C. or more and less than 140° C. is at least one selected from the group consisting of cis-1,2-dimethylcyclohexane, cis-1,3-dimethylcyclohexane, cis-1,4-dimethylcyclohexane, trans-1,2-dimethylcyclohexane, trans-1,3-dimethylcyclohexane, trans-1,4-dimethylcyclohexane and ethylcyclohexane.

[6] The moisture-proof insulating material according to any of [1] to [5], wherein the total amount of the styrene-based thermoplastic elastomer and the tackifier is 20 to 40 percent by weight based on the total weight of the moisture-proof insulating material; the total amount of the solvent is 60 to 80 percent by weight; the weight ratio between the styrene-based thermoplastic elastomer and the tackifier, contained in the moisture-proof insulating material, ranges from 2:1 to 10:1; the aliphatic hydrocarbon solvent that is contained in the moisture-proof insulating material and has a boiling point of 80° C. or more and less than 110° C. is 50 percent by weight or more based on the total amount of the solvent; and, further, the moisture-proof insulating material has a viscosity of 1.5 Pa·s or less at 25° C.

[7] The moisture-proof insulating material according to any of [1] to [6], wherein the styrene-based thermoplastic elastomer is at least one selected from the group consisting of styrene-butadiene block copolymer elastomer, styrene-isoprene block copolymer elastomer, styrene-ethylene/butylene block copolymer elastomer and styrene-ethylene/propylene block copolymer elastomer.

[8] The moisture-proof insulating material according to any of [1] to [7], wherein a content of a structural unit derived from styrene contained in the styrene-based thermoplastic elastomer is 15 to 50 percent by weight based on the total amount of the styrene-based thermoplastic elastomer.

[9] The moisture-proof insulating material according to any of [1] to [8], wherein the tackifier is a petroleum-based resin tackifier.

[10] An electronic component insulation-processed by using the moisture-proof insulating material according to any of [1] to [9].

### Advantageous Effects of Invention

The moisture-proof insulating material according to the present invention (I) has low viscosity and a sufficient solid content concentration and is excellent in workability, adhesiveness to a base material, moisture proofness and insulation reliability; and a highly moisture-proof and insulation-protected electronic component can be obtained by coating-processed with the moisture-proof insulating material.

### DESCRIPTION OF EMBODIMENTS

The present invention is specifically described below.

First, the moisture-proof insulating material according to the present invention (I) is described.

The present invention (I) is configured as the moisture-proof insulating material comprising a styrene-based thermoplastic elastomer, a tackifier and a solvent, wherein the solvent contains an aliphatic hydrocarbon solvent having a boiling point of 80° C. or more and less than 110° C.

“Thermoplastic elastomer” described herein is a polymer compound that flows by heating to be able to be subjected to molding-processing similar to that in the case of an ordinary thermoplastic and has a property exhibiting rubber elasticity (that is, significant elastic recovery) at room temperature, and the details thereof are described in “All about Thermoplastic Elastomer”, edited by the Committee for Editing Physicochemical Dictionary, First Edition, First Issue, published by Kogyo Chosakai Publishing Co., Ltd., Dec. 20, 2003.

Further, “styrene-based thermoplastic elastomer” described herein means a thermoplastic elastomer having a structural unit derived from styrene in a molecular structure.

The styrene-based thermoplastic elastomer used in the moisture-proof insulating material according to the present invention (I) is excellent in moisture resistance and insulation reliability. Examples of the styrene-based thermoplastic elastomer may include styrene-butadiene block copolymer elastomer, styrene-isoprene block copolymer elastomer, styrene-ethylene/butylene block copolymer elastomer, styrene-ethylene/propylene block copolymer elastomer, and the like. Commercially available products of such a styrene-based thermoplastic elastomer include D1101, D1102, D1155, DKX405, DKX410, DKX415, D1192, D1161, D1171, G1652 and G1730 (the above are manufactured by Kraton Performance Polymers, Inc.); TUFPRENE (registered trademark) A, TUFPRENE (registered trademark) 125, TUFPRENE (registered trademark) 126S, Tuftec (registered trademark) H1141, Tuftec (registered trademark) H1041, Tuftec (registered trademark) H1043 and Tuftec (registered trademark) H1052 (the above are manufactured by Asahi Kasei Chemicals Corp.); and the like. They may be used singly or in combination of two or more kinds.

The content of the structural unit derived from styrene contained in the styrene-based thermoplastic elastomer is preferably 15 to 50 percent by weight, more preferably 18 to 45 percent by weight, further preferably 19 to 43 percent by weight, based on the total amount of the styrene-based thermoplastic elastomer. The case of a content of the structural unit derived from styrene contained in the styrene-based thermoplastic elastomer of less than 15 percent by weight based on the total amount of the styrene-based thermoplastic elastomer may result in poor cohesion of the elastomer and is not preferred. Further, the case of more than 50 percent by weight based on the total amount of the styrene-based thermoplastic elastomer causes a tendency for the rubber property of the elastomer to disappear and a tendency to be poor in moisture-proof performance and is not preferred.

The tackifier as used herein is a substance that is blended in a polymer compound, represented by an elastomer having rubber elasticity, to have an adhesion function. The tackifier has a much smaller molecular weight than that of the polymer compound represented by an elastomer, is generally a compound in an oligomer region with a molecular weight of several hundreds to several thousands, and has the property of not exhibiting rubber elasticity in a glass state per se at room temperature.

As the tackifier, a petroleum-based resin tackifier, a terpene-based resin tackifier, a rosin-based resin tackifier, a coumarone-indene resin tackifier, a styrene-based resin tackifier or the like may be generally used.

Such petroleum-based resin tackifiers include aliphatic petroleum resins, aromatic petroleum resins, aliphatic-aromatic copolymer-based petroleum resins, alicyclic petroleum resins, dicyclopentadiene resins and modified products such as hydrogenated products thereof. The synthetic petroleum resins may be C5-based or C9-based.

Such terpene-based resin tackifiers include β-pinene resins, α-pinene resins, terpene-phenol resins, aromatic modified terpene resins, hydrogenated terpene resins and the like. The majority of these terpene-based resins are resins that do not have any polar group.

Such rosin-based resin tackifiers include rosins such as gum rosin, tall oil rosin and wood rosin; modified rosins such as hydrogenated rosins, disproportionated rosins, polymerized rosins and malleinized rosins; rosin esters such as rosin glycerol esters, hydrogenated rosin esters and hydrogenated rosin glycerol esters; and the like. These rosin-based resins have a polar group.

Among these tackifiers, the petroleum-based resin tackifiers and the terpene-based resin tackifiers are preferred. The petroleum resin tackifiers are further preferred.

These tackifiers may be used each alone or in combination of two or more kinds.

For the amount of a styrene-based thermoplastic elastomer and a tackifier which are blended, the total amount of the styrene-based thermoplastic elastomer and the tackifier which are blended is 20 to 40 percent by weight, preferably 23 to 35 percent by weight, further preferably 25 to 33 percent by weight, based on the total weight of the moisture-proof insulating material. When the total amount of the styrene-based thermoplastic elastomer and the tackifier which are blended is less than 20 percent by weight based on the total weight of the moisture-proof insulating material, the thickness of a coating material becomes small, and sufficient moisture-proof properties and film strength may not be obtained. Furthermore, a solid content concentration is decreased to prolong time before tack on the surface of the coating film disappears after application, so that productivity may be reduced. Further, in the case of the total amount of the styrene-based thermoplastic elastomer and the tackifier, which are blended, of more than 40 percent by weight based on the total weight of the moisture-proof insulating material, the viscosity of the coating material becomes high to result in poor workability, homogeneous application may be difficult, and a syringe may be clogged during potting by a dispenser, so that the case is not preferred.

The blending ratio between the styrene-based thermoplastic elastomer and the tackifier is, by weight ratio, in the range of 2:1 to 10:1, preferably in the range of 2.5:1 to 9.5:1, further preferably in the range of 3:1 to 9:1.

In the case of the blending ratio between the styrene-based thermoplastic elastomer and the tackifier of more than 10:1 by weight ratio, a sufficient adhesion function may not be able to be realized, so that the case is not preferred. Further, in the case of ₜhe blending ratio between the styrene-based thermoplastic elastomer and the tackifier of less than 2:1 by weight ratio, the tensile (breaking) strength of a film after application and drying may be significantly decreased. As a result, when a moisture-proof insulating film is torn off and removed during the repair step where a component in which a defect occurs is removed to join a new component again, the moisture-proof insulating film may be cut to be unable to be removed as one film, so that the case is not preferred.

The moisture-proof insulating material according to the present invention (I) comprises as an indispensable component an aliphatic hydrocarbon solvent having a boiling point of 80° C. or more and less than 110° C. In the present specification, unless otherwise specified, the boiling point refers to a boiling point at 1 atmospheric pressure.

Examples of the aliphatic hydrocarbon solvent having a boiling point of 80° C. or more and less than 110° C. may include n-heptane (boiling point of 98.4° C.), cyclohexane (boiling point of 80.7° C.), methylcyclohexane (boiling point of 101.1° C.) and the like. Among them, preferred are cyclohexane and methylcyclohexane. Most preferred is methylcyclohexane.

Preferably, the moisture-proof insulating material according to the present invention (I) further comprises an aliphatic hydrocarbon solvent having a boiling point of 110° C. or more and less than 140° C.

Examples of the aliphatic hydrocarbon solvent having a boiling point of 110° C. or more and less than 140° C. may include n-octane (boiling point of 125.7° C.), cis-1,2-dimethylcyclohexane (boiling point of 129.7° C.), cis-1,3-dimethylcyclohexane (boiling point of 120.1° C.), cis-1,4-dimethylcyclohexane (boiling point of 124.3° C.), trans-1,2-dimethylcyclohexane (boiling point of 123.4° C.), trans-1,3-dimethylcyclohexane (boiling point of 124.5° C.), trans-1,4-dimethylcyclohexane (boiling point of 119.4° C.), ethylcyclohexane (boiling point of 132° C.) and the like. Among them, preferred are cis-1,2-dimethylcyclohexane, cis-1,3-dimethylcyclohexane, cis-1,4-dimethylcyclohexane, trans-1,2-dimethylcyclohexane, trans-1,3-dimethylcyclohexane, trans-1,4-dimethylcyclohexane and ethylcyclohexane, and ethylcyclohexane is most preferred in consideration of availability.

Also, a solvent other than the aliphatic hydrocarbon solvent having a boiling point of 80° C. or more and less than 110° C. and the aliphatic hydrocarbon solvent having a boiling point of 110° C. or more and less than 140° C. can be used together. Such solvents include, for example, hydrocarbon solvents having an alicyclic structure such as decahydronaphthalene; acetate ester-based solvents such as n-propyl acetate, n-butyl acetate, isobutyl acetate, t-butyl acetate, isopropyl acetate and ethyl acetate; ether-based solvents such as ethylene glycol dimethyl ether, ethylene glycol diethyl ether, ethylene glycol monoethyl ether, propylene glycol dimethyl ether and propylene glycol monomethyl ether; alcohol-based solvents such as ethanol, 1-propanol and 2-propanol; ketone-based solvents such as acetone, methyl ethyl ketone and methyl isobutyl ketone; petroleum naphtha; and the like. In consideration of a drying property and workability under room temperature and windless conditions after the application of the moisture-proof insulating material, a boiling point is desirably 140° C. or less; specifically, acetate ester-based solvents such as n-butyl acetate, isobutyl acetate, t-butyl acetate, isopropyl acetate, ethyl acetate and n-propyl acetate are preferred, and n-propyl acetate, isobutyl acetate, t-butyl acetate and n-butyl acetate are further preferred.

The total amount of a solvent containing the aliphatic hydrocarbon solvent having a boiling point of 80° C. or more and less than 110° C. is preferably 60 to 80 percent by weight, more preferably 67 to 77 percent by weight, further preferably 70 to 75 percent by weight, based on the total weight of the moisture-proof insulating material.

The rate of the aliphatic hydrocarbon solvent having a boiling point of 80° C. or more and less than 110° C. to all solvents is preferably 50 to 100 percent by weight.

Further, when the aliphatic hydrocarbon solvent having a boiling point of 110° C. or more and less than 140° C. is used together, its rate to the total amount of all the solvents of the aliphatic hydrocarbon solvent having a boiling point of 80° C. or more and less than 110° C. and the aliphatic hydrocarbon solvent having a boiling point of 110° C. or more and less than 140° C. is preferably 60 to 100 percent by weight.

When the aliphatic hydrocarbon solvent having a boiling point of 80° C. or more and less than 110° C. and the aliphatic hydrocarbon solvent having a boiling point of 110° C. or more and less than 140° C. are used together, the blending ratio thereof is, by weight ratio, in the range of 50:50 to 95:5, preferably 65:35 to 95:5. When the blending ratio of the aliphatic hydrocarbon solvent having a boiling point of 80° C. or more and less than 110° C. and the aliphatic hydrocarbon solvent having a boiling point of 110° C. or more and less than 140° C. is, by weight ratio, less than 50:50, time before tack on the surface of a coating film disappear after having applied the moisture-proof insulating material may be long. In the case where the blending ratio of the aliphatic hydrocarbon solvent having a boiling point of 80° C. or more and less than 110° C. and the aliphatic hydrocarbon solvent having a boiling point of 110° C. or more and less than 140° C. is, by weight ratio, more than 95:5, drying may become excessively quick to cause the syringe of the dispenser to be clogged and a coating liquid to have stringiness when a composition has the high concentration of a styrene-based thermoplastic elastomer, so that the case is not preferred.

In accordance with the moisture-proof insulating material according to the present invention (I), the viscosity of the moisture-proof insulating material at 25° C. is preferably 1.5 Pa·s or less, more preferably 1.1 Pa·s or less, further preferably 1.0 Pa·s or less. In the case where the viscosity of the moisture-proof insulating material at 25° C. is higher than 1.5 Pa·s, in consideration of the pressure of a dispenser when it is applied, the pressure when it is applied may become too high since it is generally applied using the dispenser, it is inhibited from spreading out after the application when the moisture-proof insulating material is applied by the dispenser, and, as a result, there is apprehension that its thickness after drying becomes more larger than needed. The case is not preferred.

Viscosity described herein is a value measured by using DV-II+Pro viscometer small sample adapter (model number of spindle: SC4-31), manufactured by Brookfield Engineering Laboratories, Inc., at 25° C. and a rotational speed of 20 rpm.

In the moisture-proof insulating material according to the present invention (I), an additive such as a leveling agent, an antifoaming agent, an antioxidizing agent, a coloring agent or a silane coupling agent may be optionally used.

The leveling agent is not particularly limited as long as it is a material having the function of improving the leveling property of the surface of a coating film by adding it. Specifically, a polyether-modified dimethylpolysiloxane copolymer, a polyester-modified dimethylpolysiloxane copolymer, a polyether-modified methylalkylpolysiloxane copolymer, an aralkyl-modified methylalkylpolysiloxane copolymer and the like may be used. They may be used singly or in combination of two or more kinds. Based on 100 parts by weight of the moisture-proof insulating material according to the present invention (I), 0.01 to 3 parts by weight may be added. In the case of less than 0.01 part by weight, the effect of adding the leveling agent may not be realized. Further, in the case of more than 3 parts by weight, the surface of the coating film may be sticky or an insulating characteristic may be deteriorated depending on the kind of the leveling agent used.

The antifoaming agent is not particularly limited as long as it has the action of removing or reducing bubbles that are generated or remain when the moisture-proof insulating material according to the present invention (I) is applied. Such antifoaming agents used in the moisture-proof insulating material according to the present invention (I) include known antifoaming agents such as silicone-based oils, fluorine-containing compounds, polycarboxylic acid-based compounds, polybutadiene-based compounds and acetylene diol-based compounds. Specific examples thereof may include, e.g., silicone-based antifoaming agents such as BYK-077 (manufactured by BYK Japan KK), SN-Defoamer 470 (manufactured by San Nopco Limited), TSA750S (manufactured by Momentive Performance Materials Japan LLC) and Silicone Oil SH-203 (manufactured by Dow Corning Toray Co., Ltd.); acrylic polymer-based antifoaming agents such as Dappo SN-348 (manufactured by San Nopco Limited), Dappo SN-354 (manufactured by San Nopco Limited), Dappo SN-368 (manufactured by San Nopco Limited) and DISPARLON 230HF (manufactured by Kusumoto Chemicals, Ltd.); acetylene diol-based antifoaming agents such as Surfynol DF-110D (manufactured by Nissin Chemical Industry Co., Ltd.) and Surfynol DF-37 (manufactured by Nissin Chemical Industry Co., Ltd.); fluorine-containing silicone-based antifoaming agents such as FA-630 (manufactured by Shin-Etsu Chemical Co., Ltd.); and the like. They may be used singly or in combination of two or more kinds. Based on 100 parts by weight of the moisture-proof insulating material according to the present invention (I), 0.001 to 5 parts by weight may be usually added. In the case of less than 0.01 part by weight, the effect of adding the antifoaming agent may not be realized. Further, in the case of more than 5 parts by weight, the surface of the coating film may be sticky or an insulating characteristic may be deteriorated depending on the kind of the antifoaming agent used.

Such coloring agents include known inorganic pigments, organic pigments, organic dyes and the like, and each is blended depending on a desired color tone. An oil-soluble dye is preferred as the coloring agent used in the moisture-proof insulating material according to the present invention (I), and specific examples thereof may include, e.g., OIL BLACK860 (manufactured by Orient Chemical Industries Co., Ltd.), OIL BLACK 803 (manufactured by Orient Chemical Industries Co., Ltd.), OIL BLUE 2N (manufactured by Orient Chemical Industries Co., Ltd.), OIL BLUE 630 (manufactured by Orient Chemical Industries Co., Ltd.), SOT Black (manufactured by Hodogaya Chemical Co., Ltd.) and the like. They may be used singly or in combination of two or more kinds. Based on 100 parts by weight of the moisture-proof insulating material according to the present invention (I), 0.01 to 5 parts by weight may be usually added as the amount of these added dyes.

When it is needed to suppress oxidative degradation of the moisture-proof insulating material according to the present invention (I) and discoloration thereof during heating, the antioxidizing agent may be used and is preferred.

As the antioxidizing agent, which is not particularly limited as long as it is a compound having the action of preventing the heat deterioration and discoloration of the moisture-proof insulating material according to the present invention (I), for example, a phenolic antioxidizing agent or the like may be used.

Examples of the phenolic antioxidizing agent may include such compounds as in Formula (1) to Formula (11) described below.

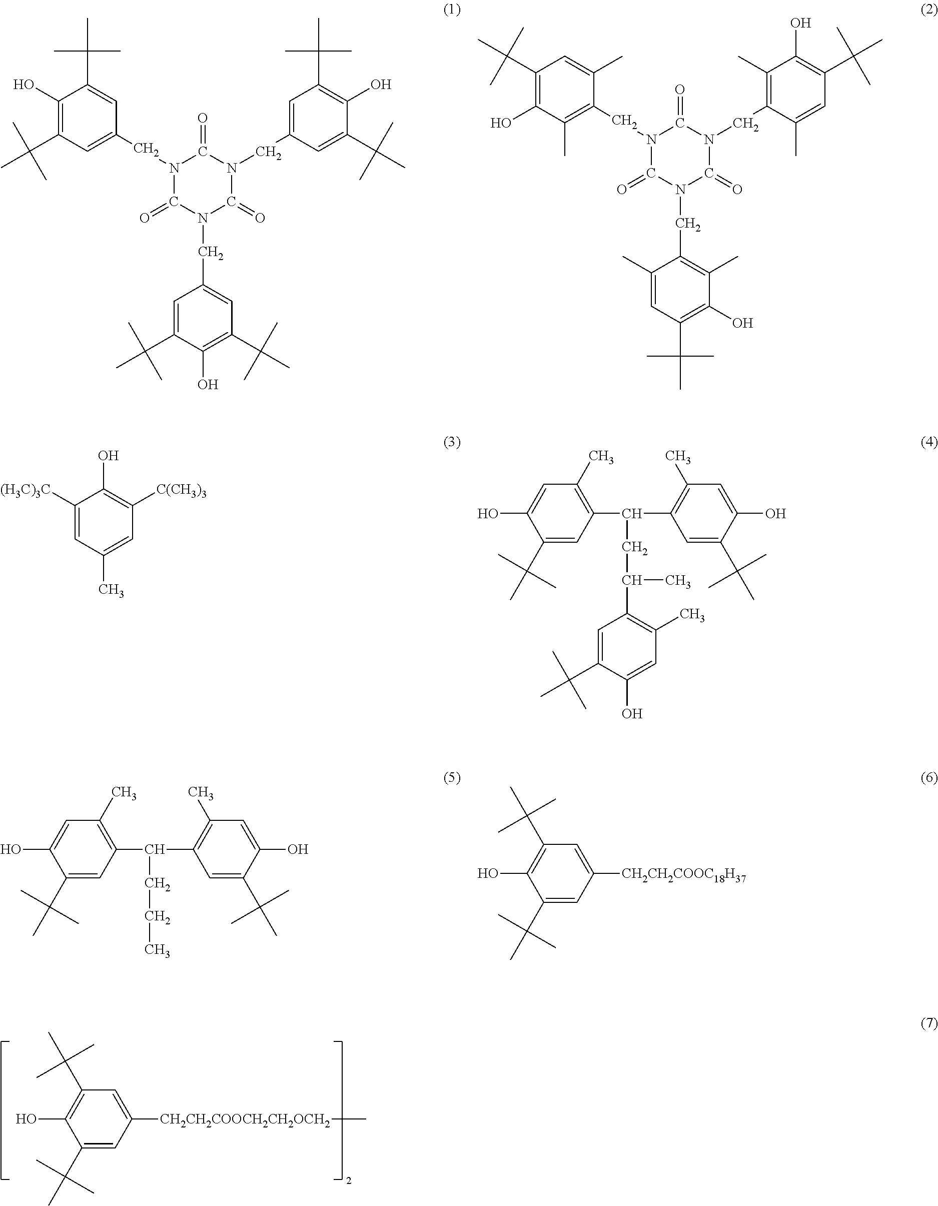

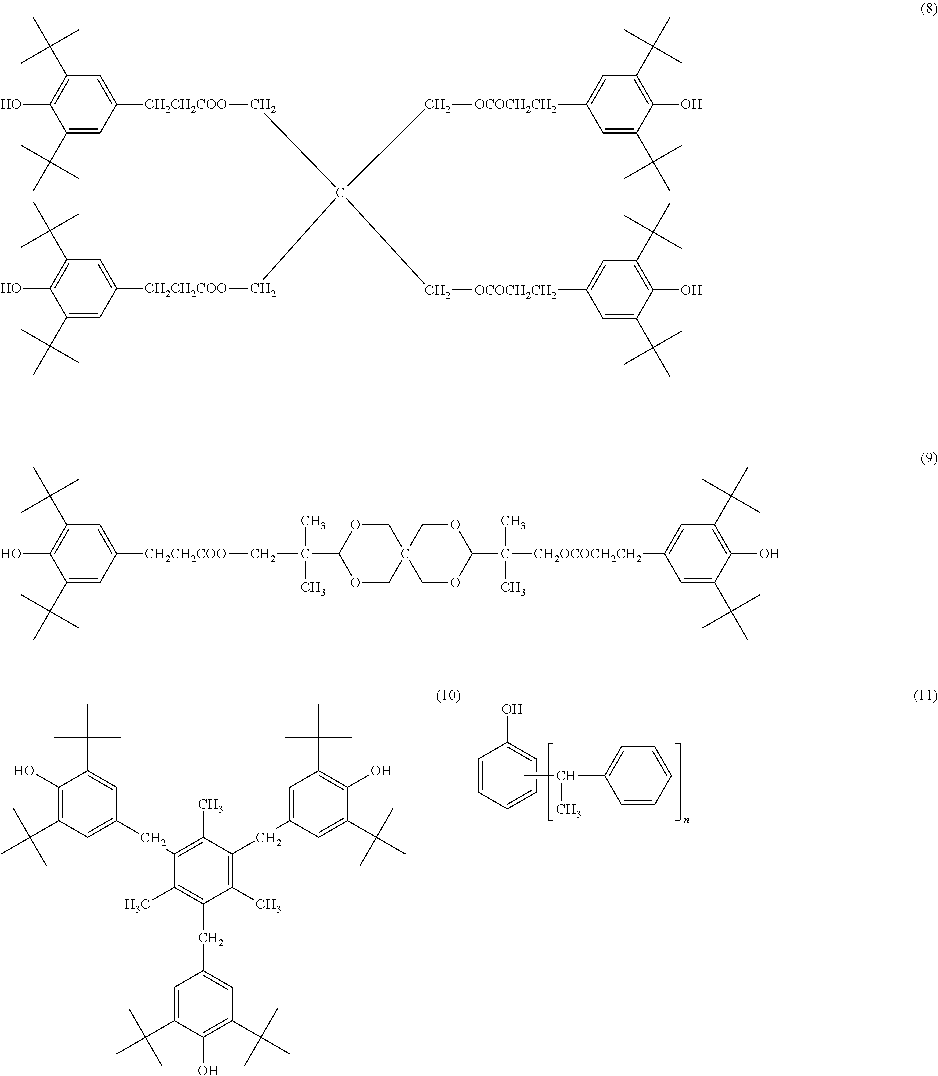

When the strong adhesiveness of a coating film, made by applying the moisture-proof insulating material according to the present invention (I), to glass or a metal oxide is needed, the silane coupling agent may be used.

The silane coupling agent is an organosilicon compound that simultaneously has a functional group reaction-bound to an organic material and a functional group reaction-bound to an inorganic material in a molecule, and its structure is generally represented by Formula (12) as described below.

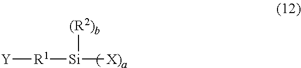

Here, Y is a functional group that is reaction-bound to an organic material and representative examples thereof include a vinyl group, an epoxy group, an amino group, a substituted amino group, a (meth)acryloyl group, a mercapto group and the like. X is a functional group that reacts with an inorganic material and generates silanol by being hydrolyzed with water or moisture. The silanol is reaction-bound to an inorganic material. Representative examples of X include an alkoxy group, an acetoxy group, a chloro chlorine atom and the like. R¹ is a divalent organic group and R² represents an alkyl group. Further, a represents an integer of 1 to 3 and b represents an integer of 0 to 2. However, a+b=3 is established.

Examples of the silane coupling agent may include 3-isocyanatepropyltriethoxysilane, 3-isocyanatepropyltrimethoxysilane, 3-isocyanatepropylmethyldiethoxysilane, 3-isocyanatepropylmethyldimethoxysilane, p-styryltrimethoxysilane, p-styryltriethoxysilane, vinyltrimethoxysilane, vinyltriethoxysilane, vinyltriisopropoxysilane, vinyltris(2-methoxyethoxy)silane, 3-acryloyloxypropyltrimethoxysilane, 3-methacryloyloxypropyltrimethoxysilane, 3-acryloyloxypropyltriethoxysilane, 3-methacryloyloxypropyltriethoxysilane, 3-acryloyloxypropylmethyldimethoxysilane, 3-methacryloyloxypropylmethyldimethoxysilane, 3-acryloyloxypropylmethyldiethoxysilane, 3-methacryloyloxypropylmethyldiethoxysilane, 2-(3,4-epoxycyclohexyl)ethyltrimethoxysilane, 3-glycidoxypropyltrimethoxysilane, 3-glycidoxypropylmethyldimethoxysilane, 3-glycidoxypropyltriethoxysilane, 3-glycidoxypropylmethyldiethoxysilane, N-2-(aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, 3-mercaptopropyltrimethoxysilane, 3-mercaptopropyltriethoxysilane, allyltrimethoxysilane and the like.

Preferred examples among these silane coupling agents include amino group-containing silane coupling agents such as N-2-(aminoethyl)-3-aminopropylmethyldimethoxysilane, N-(2-aminoethyl)-3-aminopropyltrimethoxysilane, N-(2-aminoethyl)-3-aminopropyltriethoxysilane, 3-aminopropyltrimethoxysilane, 3-aminopropyltriethoxysilane, 3-triethoxysilyl-N-(1,3-dimethyl-butylidene)propylamine and N-phenyl-3-aminopropyltrimethoxysilane; mercapto group-containing silane coupling agents such as 3-mercaptopropyltrimethoxysilane and 3-mercaptopropyltriethoxysilane; and (meth)acryloyl group-containing silane coupling agents such as 3-acryloyloxypropyltriethoxysilane, 3-methacryloyloxypropyltriethoxysilane, 3-acryloyloxypropylmethyldimethoxysilane, 3-methacryloyloxypropylmethyldimethoxysilane, 3-acryloyloxypropylmethyldiethoxysilane and 3-methacryloyloxypropylmethyldiethoxysilane, and commercially available products include KBM-503 (manufactured by Shin-Etsu Chemical Co., Ltd.), KBM-903 (manufactured by Shin-Etsu Chemical Co., Ltd.), KBE-903 (manufactured by Shin-Etsu Chemical Co., Ltd.), Z-6062 (manufactured by Dow Corning Toray Co., Ltd.), Z-6023 (manufactured by Dow Corning Toray Co., Ltd.) and the like. They may be used singly or in combination of two or more kinds.

To impart adhesiveness to a glass substrate suitable for the moisture-proof insulating material according to the present invention (I), the amount of the blended silane coupling agent is preferably 0.1 to 10 parts by weight, further preferably 0.5 to 8 parts by weight, based on 100 parts by weight of the styrene-based thermoplastic elastomer.

The present invention (II) is configured as an electronic component insulation-processed by using the moisture-proof insulating material according to the present invention (I). Such electronic components include microcomputers, transistors, condensers, resistances, relays, transformers and the like, and packaging circuit boards carrying them, and the like, and may further encompass lead wires, harnesses, film substrates and the like, which are joined to these electronic components.

Such electronic components also include the signal input parts and the like of flat panel display panels such as liquid crystal display panels, plasma display panels, organic electroluminescence panels and field emission display panels. Particularly, the moisture-proof insulating material according to the present invention (I) may be preferably used in IC peripheral parts, such as substrates for displays for electronic components, panel-laminated parts and the like.

The electronic component according to the present invention (II) is produced by insulation-processing an electronic component using the moisture-proof insulating material. As a specific method for producing the electronic component according to the present invention (II), the electronic component is obtained by, first, applying the above-mentioned moisture-proof insulating material to the above-described electronic component by a method such as a dipping method, a brush coating method, a spray method or a wire drawing application method which are generally known and volatilizing an organic solvent contained in the moisture-proof insulating material to dry a coating film.

### EXAMPLES

The present invention is further specifically described below with reference to Examples but the present invention is not limited only to Examples below.

### Example 1

A blend D1 was made by mixing 25 g of D1155 (manufactured by Kraton Performance Polymers, Inc., styrene content of 40 percent by weight) as a styrene-butadiene block copolymer elastomer, 6.1 g of Quintone (registered trademark) D100 (aliphatic-aromatic copolymer-based petroleum resin manufactured by Zeon Corporation) as a tackifier, and 53.3 g of methylcyclohexane (trade name: Swaclean MCH, manufactured by Maruzen Petrochemical Co., Ltd.) and 26.7 g of ethylcyclohexane (trade name: Swaclean ECH, manufactured by Maruzen Petrochemical Co., Ltd.) as solvents.

The blend D1 had a viscosity of 0.85 Pa·s at 25° C.

### Example 2

A blend D2 was made by mixing 22.5 g of D1155 (manufactured by Kraton Performance Polymers, Inc., styrene content of 40 percent by weight) as a styrene-butadiene block copolymer elastomer, 5.5 g of Quintone (registered trademark) D100 (manufactured by Zeon Corporation) as a tackifier, and 42 g of methylcyclohexane (trade name: Swaclean MCH, manufactured by Maruzen Petrochemical Co., Ltd.), 22 g of ethylcyclohexane (trade name: Swaclean ECH, manufactured by Maruzen Petrochemical Co., Ltd.) and 8 g of n-butyl acetate (trade name: Butyl Acetate-P, manufactured by Kyowa Hakko Chemical Co., Ltd.) as solvents.

The blend D2 had a viscosity of 0.64 Pa·s at 25° C.

### Example 3

A blend D3 was made by mixing 22.5 g of D1155 (manufactured by Kraton Performance Polymers, Inc., styrene content of 40 percent by weight) as a styrene-butadiene block copolymer elastomer, 3.0 g of Quintone (registered trademark) D100 (manufactured by Zeon Corporation) and 2.5 g of I-MARV (registered trademark) S-110 (dicyclopentadiene/aromatic copolymer-based hydrogenated petroleum resin containing a C5 fraction as a main component, manufactured by Idemitsu Kosan Co., Ltd.) as tackifiers, and 42 g of methylcyclohexane (trade name: Swaclean MCH, manufactured by Maruzen Petrochemical Co., Ltd.), 22 g of ethylcyclohexane (trade name: Swaclean ECH, manufactured by Maruzen Petrochemical Co., Ltd.) and 8 g of n-butyl acetate (trade name: Butyl Acetate-P, manufactured by Kyowa Hakko Chemical Co., Ltd.) as solvents.

The blend D3 had a viscosity of 0.66 Pa·s at 25° C.

### Example 4

A blend D4 was made by mixing 22.5 g of D1161 (manufactured by Kraton Performance Polymers, Inc., styrene content of 15 percent by weight) as a styrene-isoprene block copolymer elastomer, 5.5 g of Quintone (registered trademark) D100 (manufactured by Zeon Corporation) as a tackifier, and 36.0 g of methylcyclohexane (trade name: Swaclean MCH, manufactured by Maruzen Petrochemical Co., Ltd.), 31.0 _{g} of ethylcyclohexane (trade name: Swaclean ECH, manufactured by Maruzen Petrochemical Co., Ltd.) and 5 g of n-butyl acetate (trade name: Butyl Acetate-P, manufactured by Kyowa Hakko Chemical Co., Ltd.) as solvents.

The blend D4 had a viscosity of 1.20 Pa·s at 25° C.

### Example 5

A blend D5 was made by mixing 25 g of D1155 (manufactured by Kraton Performance Polymers, Inc., styrene content of 40 percent by weight) as a styrene-butadiene block copolymer elastomer, 6.1 g of Quintone (registered trademark) D100 (manufactured by Zeon Corporation) as a tackifier, and 98.5 g of methylcyclohexane (trade name: Swaclean MCH, manufactured by Maruzen Petrochemical Co., Ltd.) as a solvent.

The blend D5 had a viscosity of 0.30 Pa·s at 25° C.

### Comparative Example 1

A blend E1 was made by mixing 20 g of D1161 (manufactured by Kraton Performance Polymers, Inc., styrene content of 15 percent by weight) as a styrene-isoprene block copolymer elastomer, 10 g of I-MARV (registered trademark) P-100 (dicyclopentadiene/aromatic copolymer-based hydrogenated petroleum resin containing a C5 fraction as a main component, manufactured by Idemitsu Kosan Co., Ltd. (P grade is a grade having a higher hydriding (hydrogenation) rate than that of S grade.)) as a tackifier, 1 g of N-2-(aminoethyl)-3-aminopropylmethyldimethoxysilane (trade name: KBM-602, manufactured by Shin-Etsu Chemical Co., Ltd.) as a silane coupling agent, and 70 g of ethylcyclohexane (trade name: Swaclean ECH, manufactured by Maruzen Petrochemical Co., Ltd.) as a solvent.

The blend E1 had a viscosity of 1.11 Pa·s at 25° C.

### Comparative Example 2

A blend E2 was made by mixing 20 g of G1652 (manufactured by Kraton Performance Polymers, Inc., styrene ,content of 30 percent by weight) as a styrene-ethylene/butylene block copolymer elastomer and 20 g of a styrene-butadiene block copolymer elastomer D1101 (manufactured by Kraton Performance Polymers, Inc., styrene content of 31 percent by weight), 10 g of I-MARV (registered trademark) P-100 (dicyclopentadiene/aromatic copolymer-based hydrogenated petroleum resin containing a C5 fraction as a main component, manufactured by Idemitsu Kosan Co., Ltd.) as a tackifier, 1 g of N-2-(aminoethyl)-3-aminopropylmethyldimethoxysilane (trade name: KBM-602, manufactured by Shin-Etsu Chemical Co., Ltd.) as a silane coupling agent, and 70 g of ethylcyclohexane (trade name: Swaclean ECH, manufactured by Maruzen Petrochemical Co., Ltd.) as a solvent.

The viscosity of the blend E2 at 25° C. was too high to perform measurement on the above-described viscosity measurement conditions.

### Comparative Example 3

A blend E3 was made by mixing 25 g of D1155 (manufactured by Kraton Performance Polymers, Inc., styrene content of 40 percent by weight) as a styrene-butadiene block copolymer elastomer, 6.1 g of Quintone (registered trademark) D100 (aliphatic-aromatic copolymer-based petroleum resin, manufactured by Zeon Corporation) as a tackifier, and 80 g of ethylcyclohexane (trade name: Swaclean ECH, manufactured by Maruzen Petrochemical Co., Ltd.) as a solvent.

The blend E3 had a viscosity of 0.88 Pa·s at 25° C.

### Comparative Example 4

A blend E4 was made by mixing 22.5 g of D1155 (manufactured by Kraton Performance Polymers, Inc., styrene content of 40 percent by weight) as a styrene-butadiene block copolymer elastomer, 5.5 g of Quintone (registered trademark) D100 (manufactured by Zeon Corporation) as a tackifier, and 64 g of ethylcyclohexane (trade name: Swaclean ECH, manufactured by Maruzen Petrochemical Co., Ltd.) and 8 g of n-butyl acetate (trade name: Butyl Acetate-P, manufactured by Kyowa Hakko Chemical Co., Ltd.) as solvents.

The blend E4 had a viscosity of 0.66 Pa·s at 25° C.

### Comparative Example 5

A blend E5 was made by mixing 22.5 g of D1155 (manufactured by Kraton Performance Polymers, Inc., styrene content of 40 percent by weight) as a styrene-butadiene block copolymer elastomer, 3.0 g of Quintone (registered trademark) D100 (manufactured by Zeon Corporation) and 2.5 g of I-MARV (registered trademark) S-110 (dicyclopentadiene/aromatic copolymer-based hydrogenated petroleum resin containing a C5 fraction as a main component, manufactured by Idemitsu Kosan Co., Ltd.) as tackifiers, and 64 g of ethylcyclohexane (trade name: Swaclean ECH, manufactured by Maruzen Petrochemical Co., Ltd.) and 8 g of n-butyl acetate (trade name: Butyl Acetate-P, manufactured by Kyowa Hakko Chemical Co., Ltd.) as solvents.

The blend E5 had a viscosity of 0.68 Pa·s at 25° C.

### Comparative Example 6

A blend E6 was made by mixing 22.5 g of D1161 (manufactured by Kraton Performance Polymers, Inc., styrene content of 15 percent by weight) as a styrene-isoprene block copolymer elastomer, 5.5 g of Quintone (registered trademark) D100 (manufactured by Zeon Corporation) as a tackifier, and 67 g of ethylcyclohexane (trade name: Swaclean ECH, manufactured by Maruzen Petrochemical Co., Ltd.) and 5 g of n-butyl acetate (trade name: Butyl Acetate-P, manufactured by Kyowa Hakko Chemical Co., Ltd.) as solvents.

The blend E6 had a viscosity of 1.22 Pa·s at 25° C.

### Comparative Example 7

A blend E7 was made by mixing 25 g of D1155 (manufactured by Kraton Performance Polymers, Inc., styrene content of 40 percent by weight) as a styrene-butadiene block copolymer elastomer, 6.1 g of Quintone (registered trademark) D100 (manufactured by Zeon Corporation) as a tackifier, and 98.5 g of ethylcyclohexane (trade name: Swaclean ECH, manufactured by Maruzen Petrochemical Co., Ltd.) as a solvent.

The blend E7 had a viscosity of 0.32 Pa·s at 25° C.

[Evaluation of Blends]

The characteristics of the blends D1 to D5, E1, and E3 to E7, prepared in the above-described compositions were evaluated by a method described below. The results are listed in Table 1 and Table 2.

<Measurement of Viscosity>

Viscosity was measured by the following method.

The value of viscosity that was almost constant was measured on the conditions of a temperature of 25.0° C. and a rotational speed of 20 rpm by using a viscometer (model: DV-II+Pro, manufactured by Brookfield Engineering Laboratories, Inc.) with a small sample adapter and a spindle having a model number of C4-31 employing 10 mL of a sample.

<Evaluation of Tack-Free Time>

Tack-free time was evaluated by the following method.

Each of the blends D1 to D5 and the blends E1 and E3 to E7 was applied onto glass using a dispenser so that its thickness after drying was about 130 μm, and the presence or absence of stickiness on the surface of a coating film was confirmed by touch every 30 seconds after the application. Time until stickiness was first lost was regarded as tack-free time.

Tack-free time is an index for a quick-drying property and is preferably shorter.

The blend E2 was not able to be applied by the dispenser because of having excessively high viscosity.

<Evaluation of Adhesiveness to Glass and Tearing-off Property from Glass>

Adhesiveness to glass was evaluated by the following method.

Each of the blends D1 to D5 and the blends E1 and E3 to E7 was applied onto glass so that its thickness after drying was 130 μm, maintained for 10 minutes at room temperature, thereafter dried for 0.5 hour at 70° C., and thereafter left standing for 12 hours at room temperature. Only one end of a cured film for an evaluation test in these coating films was peeled to produce a test piece for measuring adhesive strength, having a width of 2.5 mm. Adhesive strength was determined by fixing a cured film peeled from the glass plate on a tensile tester (EZ Test/CE, manufactured by Shimadzu Corporation) so as to form an angle of 90° and measuring 90° tearing-off strength at a first distance between chucks of 2.5 cm and a rate of 50 mm/min at 23° C. The results are listed in Table 1 and Table 2.

A mark “X” in “tearing-off property” means that a cured film was cut during measuring 90° tearing-off strength while a mark “G” in “tearing-off property” means that a cured film was not cut but was able to be peeled during measuring 90° tearing-off strength.

Although adhesiveness to some extent is needed for maintaining moisture proofness and insulation reliability, a coating film can be preferably neatly torn off without being cut when desirably torn off because it is desired to reuse a glass panel (to dispose of a flexible wiring board) when there is any defect in an inspection before shipment of an LCD panel.

<Evaluation of Adhesiveness to Polyimide Film and Evaluation of Tearing-off Property from Polyimide>

Adhesiveness to a polyimide film was evaluated by the following method.

Each of the blends D1 to D5 and the blends E1 and E3 to E7 was applied onto a polyimide film (trade name: Kapton (registered trademark) 150EN, manufactured by Du Pont-Toray Co., Ltd.) so that its thickness after drying was 130 μm, maintained for 10 minutes at room temperature, thereafter dried for 0.5 hour at 70° C., and thereafter left standing for 12 hours at room temperature. Then, a board, in which an epoxy resin board with a glass cloth was affixed to the surface, onto which no blend is applied, of this polyimide film, with a double-coated adhesive tape (hereinafter referred to as “polyimide film-affixed epoxy resin board”), was produced. Only one end of a cured film for an evaluation test in these coating films was peeled to produce a test piece for measuring adhesive strength, having a width of 2.5 mm. Adhesive strength was determined by fixing a cured film peeled from the polyimide film-affixed epoxy resin board on a tensile tester (EZ Test/CE, manufactured by Shimadzu Corporation) so as to form an angle of 90° and measuring 90° tearing-off strength at a first distance between chucks of 2.5 cm and a rate of 50 mm/min at 23° C. The results are listed in Table 1 and Table 2.

A mark “X” in “tearing-off property” means that a cured film was cut during measuring 90° tearing-off strength while a mark “G” in “tearing-off property” means that a cured film was not cut but was able to be peeled during measuring 90° tearing-off strength.

<Evaluation of Moisture Vapor Transmission Rate>

A free standing film was produced by applying several layers of each of the blends D1 to D5 and the blends E1 and E3 to E7 onto a Teflon (registered trademark) board so that its thickness after drying was about 130 μm by using a bar coater.

The moisture vapor transmission rates of these free standing films were measured using Moisture Pervious Cups (manufactured by Tester Sangyo Co., Ltd.) according to JIS Z0208. The results are listed in Table 1 and Table 2.

Test conditions for a moisture vapor transmission rate were a temperature of 40° C., a humidity of 90% RH and 24 hours.

<Evaluation of Long-Term Electrical Insulation Reliability Using Flexible Substrate>

Each of the blends D1 to D5, E1, and E3 to E7 was applied onto a flexible wiring board in which a substrate with a fine comb pattern shape (copper wire width/width between copper wires=15 μm/15 μm) which was produced by etching a flexible copper clad laminate (manufactured by Sumitomo Metal Mining Co., Ltd., grade name: S'PERFLEX, copper thickness: 8 μm, polyimide thickness: 38 μm) and described in JPCA-ET01 was subjected to a tinning process so that its thickness after drying was 100 μm, maintained at room temperature for 10 minutes, and thereafter dried at 70° C. for 1.5 hours.

A bias voltage of 30 V was applied using this test piece to conduct a temperature and humidity routine test using MIGRATION TESTER MODEL MIG-8600 (manufactured by IMV Corporation) on the conditions of a temperature of 85° C. and a humidity of 85% RH. Resistance values after 1000 hours from the start of the above-described temperature and humidity routine test are listed in Table 1 and Table 2.

<Evaluation of Long-Term Insulation Reliability Using Wiring on Glass Substrate>

Each of the blends D1 to D5, E1, and E3 to E7 was applied onto a pattern electrode in which ITO wiring with line/space of 40 μm/10 μm and a comb pattern shape was formed on a glass substrate so that its thickness after drying was 100 pm, maintained at room temperature for 10 minutes, and thereafter dried at 70° C. for 1.5 hours.

A bias voltage of 30 V was applied using this test piece to conduct a temperature and humidity routine test using MIGRATION TESTER MODEL MIG-8600 (manufactured by IMV Corporation) on the conditions of a temperature of 85° C. and a humidity of 85% RH. Resistance values in the early period of the start of the above-described temperature and humidity routine test and after 1000 hours from the start are listed in Table 1 and Table 2.

TABLE 1

| | | | | | | | | Comparative | Comparative |
|---|---|---|---|---|---|---|---|---|---|
| | | | Example 1 | Example 2 | Example 3 | Example 4 | Example 5 | Example 1 | Example 2 |
| D1155 | | g | 25 | 22.5 | 22.5 | 0 | 25 | 0 | 0 |
| D1161 | | g | 0 | 0 | 0 | 22.5 | 0 | 20 | 0 |
| G1652 | | g | 0 | 0 | 0 | 0 | 0 | 0 | 20 |
| D1101 | | g | 0 | 0 | 0 | 8 | 0 | 0 | 20 |
| Quintone ® D100 | | g | 6.1 | 5.5 | 3.0 | 5.5 | 6.1 | 0 | 0 |
| I-MARV ® S-110 | | g | 0 | 0 | 2.5 | 0 | 0 | 0 | 0 |
| I-MARV ® P-100 | | g | 0 | 0 | 0 | 0 | 0 | 10 | 10 |
| KBM-602 | | g | 0 | 0 | 0 | 0 | 0 | 1 | 1 |
| Methylcyclohexane | | g | 53.3 | 42 | 42 | 36.0 | 98.5 | 0 | 0 |
| Ethylcyclohexane | | g | 26.7 | 22 | 22 | 31.0 | 0 | 70 | 70 |
| n-Butyl acetate | | g | 0 | 8 | 8 | 5 | 0 | 0 | 0 |
| Viscosity | | Pa · S | 0.85 | 0.64 | 0.66 | 1.20 | 0.30 | 1.11 | The |
| | | | | | | | | | measurement |
| | | | | | | | | | was impossible |
| | | | | | | | | | on the same |
| | | | | | | | | | measurement |
| | | | | | | | | | conditions at |
| | | | | | | | | | high viscosity. |
| Tack-free time | | min | 2.0 | 2.5 | 2.5 | 3.0 | 2.0 | 5.0 | The |
| | | | | | | | | | measurement |
| | | | | | | | | | was impossible |
| | | | | | | | | | since it was |
| | | | | | | | | | not able to |
| | | | | | | | | | be well |
| | | | | | | | | | applied from |
| | | | | | | | | | the dispenser |
| | | | | | | | | | due to high |
| | | | | | | | | | viscosity. |
| Adhesiveness to glass | | N/cm | 2.0 | 1.7 | 1.8 | 1.2 | 2.0 | 1.0 | |
| Tearing-off property of coating | | | G | G | G | G | G | G | |
| film from glass | | | | | | | | | |
| Adhesiveness to polyimide film | | N/cm | 2.8 | 2.8 | 3.2 | 1.2 | 2.8 | Measurement | — |
| | | | | | | | | was | |
| | | | | | | | | impossible | |
| | | | | | | | | since the | |
| | | | | | | | | coating film | |
| | | | | | | | | was severely | |
| | | | | | | | | cut. | |
| Tearing-off property of coating | | G | G | G | G | G | X | | |
| film from polyimide | | | | | | | | | |
| Moisture vapor transmission rate | | g/m² | 70 | 70 | 70 | 86 | 70 | 80 | 60 |
| | | 24 hrs | | | | | | | |
| Long-term electrical | Resistance | Ω | 2 × 10⁹ | 2 × 10⁹ | 2 × 10⁹ | 1 × 10⁹ | 2 × 10⁹ | 1 × 10⁹ | — |
| insulation reliability | value after | | | | | | | | |
| using flexible | 1000 hours | | | | | | | | |
| substrate | | | | | | | | | |
| Long-term electrical | Resistance | Ω | 3 × 10⁹ | 2 × 10⁹ | 3 × 10⁹ | 2 × 10⁹ | 3 × 10⁹ | 2 × 10⁹ | — |
| insulation reliability | value after | | | | | | | | |
| using glass substrate | 1000 hours | | | | | | | | |

TABLE 2

| | | | Comparative | Comparative | Comparative | Comparative | Comparative |
|---|---|---|---|---|---|---|---|
| | | | Example 3 | Example 4 | Example 5 | Example 6 | Example 7 |
| D1155 | | g | 25 | 22.5 | 22.5 | 0 | 25 |
| D1161 | | g | 0 | 0 | 0 | 22.5 | 0 |
| G1652 | | g | 0 | 0 | 0 | 0 | 0 |
| D1101 | | g | 0 | 0 | 0 | 0 | 0 |
| Quintone ® D100 | | g | 6.1 | 5.5 | 3.0 | 5.5 | 6.1 |
| I-MARV ® S-110 | | g | 0 | 0 | 2.5 | 0 | 0 |
| I-MARV ® P-100 | | g | 0 | 0 | 0 | 0 | 0 |
| KBM-602 | | g | 0 | 0 | 0 | 0 | 0 |
| Methylcyclohexane | | g | 0 | 0 | 0 | 0 | 0 |
| Ethylcyclohexane | | g | 80 | 64 | 64 | 67 | 98.5 |
| n-Butyl acetate | | g | 0 | 8 | 8 | 5 | 0 |
| Viscosity | | Pa · s | 0.88 | 0.66 | 0.68 | 1.22 | 0.32 |
| Tack-free time | | min | 6.0 | 5.5 | 5.5 | 5.5 | 7.0 |
| Adhesiveness to glass | | N/cm | 2.0 | 1.7 | 1.8 | 1.2 | 2.0 |
| Tearing-off property of coating film | | | G | G | G | G | G |
| from glass | | | | | | | |
| Adhesiveness to polyimide film | | N/cm | 2.8 | 2.8 | 3.2 | 1.2 | 2.8 |
| Tearing-off property of coating film | | | G | G | G | G | G |
| from polyimide | | | | | | | |
| Moisture vapor transmission rate | | g/m² · 24 hrs | 70 | 70 | 70 | 80 | 70 |
| Long-term electrical | Resistance | Ω | 2 × 10⁹ | 2 × 10⁹ | 2 × 10⁹ | 1 × 10⁹ | 2 × 10⁹ |
| insulation | value after | | | | | | |
| reliability using | 1000 hours | | | | | | |
| flexible substrate | | | | | | | |
| Long-term electrical | Resistance | Ω | 3 × 10⁹ | 2 × 10⁹ | 3 × 10⁹ | 2 × 10⁹ | 3 × 10⁹ |
| insulation | value after | | | | | | |
| reliability using | 1000 hours | | | | | | |
| glass substrate | | | | | | | |

The results in Table 1 and Table 2 reveal that the blends D1 to D5 are superior in drying property, adhesiveness to a glass substrate and long-term insulation reliability and have low viscosities of less than 1.5 Pa·s (particularly, the viscosities of D1 to D3 and D5 are less than 1.0 Pa·s). In contrast, the results reveal that the blend E2 has a high viscosity and poor handleability and the blends E1 and E3 to E7 are inferior in drying rate, so that the composition according to the present invention is found to be suitable for a moisture-proof insulating material applied using a dispenser.

### INDUSTRIAL APPLICABILITY

The moisture-proof insulating material according to the present invention is a composition capable of realizing low viscosity and a quick-drying property, and a highly moisture-proof and insulation-protected electronic component can be obtained by coating-processed with the moisture-proof insulating material.

1. A moisture-proof insulating material comprising a styrene-based thermoplastic elastomer, a tackifier and a solvent, wherein the solvent contains an aliphatic hydrocarbon solvent having a boiling point of 80° C. or more and less than 110° C.

2. The moisture-proof insulating material according to claim 1, wherein the solvent further contains an aliphatic hydrocarbon solvent having a boiling point of 110° C. or more and less than 140° C.

3. The moisture-proof insulating material according to claim 2, wherein a weight ratio between the aliphatic hydrocarbon solvent having a boiling point of 80° C. or more and less than 110° C. and the aliphatic hydrocarbon solvent having a boiling point of 110° C. or more and less than 140° C., contained in the moisture-proof insulating material, ranges from 50:50 to 95:5.

4. The moisture-proof insulating material according to claim 1, wherein the aliphatic hydrocarbon solvent having a boiling point of 80° C. or more and less than 110° C. is cyclohexane and/or methylcyclohexane.

5. The moisture-proof insulating material according to claim 2, wherein the aliphatic hydrocarbon solvent having a boiling point of 110° C. or more and less than 140° C. is at least one selected from the group consisting of cis-1,2-dimethylcyclohexane, cis-1,3-dimethylcyclohexane, cis-1,4-dimethylcyclohexane, trans-1,2-dimethylcyclohexane, trans-1,3-dimethylcyclohexane, trans-1,4-dimethylcyclohexane and ethylcyclohexane.

6. The moisture-proof insulating material according to claim 1, wherein the total amount of the styrene-based thermoplastic elastomer and the tackifier is 20 to 40 percent by weight based on the total weight of the moisture-proof insulating material; the total amount of the solvent is 60 to 80 percent by weight;
the weight ratio between the styrene-based thermoplastic elastomer and the tackifier, contained in the moisture-proof insulating material, ranges from 2:1 to 10:1; the aliphatic hydrocarbon solvent that is contained in the moisture-proof insulating material and has a boiling point of 80° C. or more and less than 110° C. is 50 percent by weight or more based on the total amount of the solvent; and, further, the moisture-proof insulating material has a viscosity of 1.5 Pa·s or less at 25° C.

7. The moisture-proof insulating material according to claim 1, wherein the styrene-based thermoplastic elastomer is at least one selected from the group consisting of styrene-butadiene block copolymer elastomer, styrene-isoprene block copolymer elastomer, styrene-ethylene/butylene block copolymer elastomer and styrene-ethylene/propylene block copolymer elastomer.

8. The moisture-proof insulating material according to claim 1, wherein a content of a structural unit derived from styrene contained in the styrene-based thermoplastic elastomer is 15 to 50 percent by weight based on the total amount of the styrene-based thermoplastic elastomer.

9. The moisture-proof insulating material according to claim 1, wherein the tackifier is a petroleum-based resin tackifier.

10. An electronic component insulation-processed by using the moisture-proof insulating material according to claim 1.

11. The moisture-proof insulating material according to claim 2, wherein the aliphatic hydrocarbon solvent having a boiling point of 80° C. or more and less than 110° C. is cyclohexane and/or methylcyclohexane.

12. The moisture-proof insulating material according to claim 3, wherein the aliphatic hydrocarbon solvent having a boiling point of 80° C. or more and less than 110° C. is cyclohexane and/or methylcyclohexane.
